(19) United States
(12) Patent Application Publication
(10) Pub. No.: US 2009/0209420 A1
(43) Pub. Date: Aug. 20, 2009

(54) HYPERABSORPTIVE NANOPARTICLE COMPOSITIONS

(75) Inventors: Rajdeep S. Kalgutkar, Woodbury, MN (US); Mario A. Perez, Burnsville, MN (US); Janet R. Kirkman, Minneapolis, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/417,203

(22) Filed: Apr. 2, 2009

Related U.S. Application Data
(63) Continuation of application No. 11/275,034, filed on Dec. 5, 2005.

(51) Int. Cl. B41M 5/26

(52) U.S. Cl. 503/201; 503/200

(57) ABSTRACT

A multilayer article is provided comprising a metallic nanoparticle layer and a reflective film layer. The article may be marked on exposure to incident light.

This application is a continuation of U.S. patent application Ser. No. 11/275,034, filed Dec. 5, 2005, the entire content of which is hereby incorporated herein by reference.

### FIELD OF THE INVENTION

The present invention is directed to a multilayer article that may be marked or imaged by application of light energy.

### BACKGROUND

Metallic nanoparticles, having a diameter of about 1-100 nanometers (nm), are important materials for applications including semiconductor technology, magnetic storage, electronics fabrication, and catalysis. Metallic nanoparticles have been produced by gas evaporation; by evaporation in a flowing gas stream; by mechanical attrition; by sputtering; by electron beam evaporation; by thermal evaporation; by electron beam induced atomization of binary metal azides; by expansion of metal vapor in a supersonic free jet; by inverse micelle techniques; by laser ablation; by laser-induced breakdown of organometallic compounds; by pyrolysis of organometallic compounds; by microwave plasma decomposition of organometallic compounds, and by other methods.

It is known that metallic nanoparticles possess certain unique optical properties. In particular, metallic nanoparticles display a pronounced optical resonance. This so-called plasmon resonance is due to the collective coupling of the conduction electrons in the metal sphere to the incident electromagnetic field. This resonance can be dominated by absorption or scattering depending on the radius of the nanoparticle with respect to the wavelength of the incident electromagnetic radiation. Associated with this plasmon resonance is a strong local field enhancement in the interior of the metal nanoparticle. A variety of potentially useful devices can be fabricated to take advantage of these specific optical properties. For example, optical filters or chemical sensors based on surface enhanced Raman scattering (SERS) have been fabricated.

Over the past decade, interest in the unique optical properties of metallic nanoparticles has increased considerably with respect to the use of suspensions and films incorporating these nanoparticles for the purposes of exciting surface plasmons to enable the detection of SPR spectra. In addition, Surface Enhanced Raman Spectroscopy (SERS) for infrared absorbance spectral information and surface enhanced fluorescence for enhanced fluorescence stimulation can also be detected. Metallic nanoparticles display large absorbance bands in the visible wavelength spectrum yielding colorful colloidal suspensions. The physical origin of the light absorbance is due to incident light energy coupling to a coherent oscillation of the conduction band electrons on the metallic nanoparticle. This coupling of incident light is unique to discrete nanoparticles and films formed of nanoparticles (referred to as metallic island films).

Sheeting materials having a graphic image or other mark have been widely used, particularly as labels for authenticating an article or document. For example, sheetings such as those described in U.S. Pat. Nos. 3,154,872; 3,801,183; 4,082,426; and 4,099,838 have been used as validation stickers for vehicle license plates, and as security films for driver's licenses, government documents, audio and video compact disks, playing cards, beverage containers, and the like. Other uses include graphics applications for identification purposes such as on police, fire or other emergency vehicles, in advertising and promotional displays and as distinctive labels to provide brand enhancement.

### SUMMARY

The present invention is directed to a multilayer article comprising a metallic nanoparticle layer and a reflective film layer, each of which may comprise one or more layers. Upon application of light energy of a preselected wavelength or wavelength region, the nanoparticle layer absorbs at least a portion of the incident light energy, converting it to heat, which changes the optical characteristics of the article, allowing marks, text, or indicia to be inscribed thereon. The metallic nanoparticle layer may comprise a discreet nanoparticle layer, or may comprise a dispersion of metallic nanoparticles in a polymer layer. By ‘metallic” it is meant elemental metals and compounds thereof.

The article can be useful as a markable article whereby incident light energy, such as from a laser source, is absorbed by the metallic nanoparticles causing localized heating, and thereby changing the optical characteristics of the article, such as by a permanent darkening, color change, or change in the index of refraction. The reflective layer improves the efficiency of the incident light transfer to the article by reflecting light transmitted through the nanoparticle layer back to the nanoparticle layer. By “markable” it is meant that mark, image, text, figures, or other indicia may be permanently inscribed in the article by application of light energy. The markable article may be marked by application of light of a preselected wavelength or wavelength region (bandwidth) in the infrared (including near, mid and far infrared), visible or UV regions of the electromagnetic spectrum. The marks imparted to the article are preferably visible to the naked eye, but may alternatively be visualized under incident UV or IR light.

An article having a mark, image, text or other indicia may be used in a variety of applications such as securing tamperproof images in passports, ID badges, event passes, affinity cards, product identification formats, such as bar codes, and advertising promotions for verification and authenticity. Unlike surface print techniques, such as screen-printing or transfer printing, the articles of the invention resist mechanical damage, abrasion, and environmental damage. Further, the invention provides a markable substrate that may be applied or imaged by non-contact means at high speeds.

### BRIEF DESCRIPTION OF THE FIGURES

FIGS. 1-3 show cross-sectional representations of various embodiments of the articles of the invention.

FIG. 4 are transmission spectra for the article of Example 1.

FIGS. 5 to 9 are electron micrographs of the imaged article of Example 1.

### DETAILED DESCRIPTION

The present invention provides a multilayer article comprising a metallic nanoparticle layer and a reflective film layer, each of which may comprise one or more layers. The metallic nanoparticle layer may comprise a discreet nanoparticle layer, or may comprise a dispersion of metallic nanoparticles in a polymer layer. By ‘metallic” it is meant elemental metals and compounds thereof.

The present invention further provides a marking film whereby incident light energy or a preselected wavelength or wavelength region, such as from a laser source, is absorbed by the metallic nanoparticles causing localized heating, and thereby changing the optical characteristics of the article. The localized heating may result in melting, burning or charring of the polymer near the nanoparticles resulting in a change in the optical characteristics. Typically, the area of incident light darkens or changes color allowing text or other indicia to be “inscribed” on or in the article. Much of the incident light is transmitted through the nanoparticle layer, or otherwise scattered and not absorbed by the nanoparticles. The reflective layer improves the efficiency of the incident light energy transfer to the article by reflecting light transmitted through the nanoparticle layer back to the nanoparticle layer.

Generally the absorbance maximum of the nanoparticles and the reflection maximum of the reflective layer are chosen to be coincident with the wavelength or bandwidth of a preselected light source. Further, in embodiments where the nanoparticle layer comprises metallic nanoparticles dispersed in a polymer matrix, the polymer is chosen so as to be transmissive at the wavelength or bandwidth of a preselected light source. The nanoparticle/polymer layer may be of any thickness, provided the transparency of the polymer and absorbance of the nanoparticles is sufficient to impart a mark thereto.

Useful metals that may be used in the metallic nanoparticles of the present invention include, for example, Li, Na, K, Rb, Cs, Fr, Be, Mg, Ca, Sr, Ba, Ra, Y, La, Ac, Ti, Zr, Hf, V, Nb, Ta, Cr, Mo, W, Mn, Tc, Re, Fe, Ru, Os, Co, Rh, Ir, Ni, Pd, Pt, Cu, Ag, Au, Zn, Cd, Al, In, Tl, Sn, Pb, mixtures, oxides and alloys of these metals and even the lanthanides and actinides, if desired. Particularly useful metals are gold, aluminum, copper, iron, platinum, palladium, iridium, rhodium, osmium, ruthenium, titanium, cobalt, vanadium, magnesium, silver, zinc, and cadmium, indium, lanthanum, indium tin oxide (ITO) and antimony tin oxide (ATO), antimony indium tin oxide (AITO), tin, boron, lanthanum hexaboride, rare earth metals and mixtures and alloys thereof. Most preferred are the noble metals. Other metals are apparent to those skilled in the art.

The metallic nanoparticles also include nanoshells such as those described in U.S. Pat. No. 6,344,272 (Oldenburg et al.) and U.S. Published Appln. 2003/0156991 (Halas) et al.), incorporated herein by reference. The reference describes nanoparticles comprised of a nonconducting inner layer that is surrounded by an electrically conducting material. The ratio of the thickness of the nonconducting layer to the thickness of the outer conducting shell is determinative of the wavelength of maximum absorbance or scattering of the particle. The references note that a serious practical limitation to realizing many applications of solid metal nanoparticles is the inability to position the plasmon resonance at desired wavelengths. By adjusting the relative core and shell thickness, and selection of materials, metal nanoshells may be prepared that will absorb or scatter light at any wavelength across much of the ultraviolet, visible and infrared range of the electromagnetic spectrum.

In one embodiment, the present invention provides a discontinuous metallic nanoparticle coating on a thermoplastic polymeric film, the nanoparticles having a mean number average particle diameter in the range of 1 to 100 nanometers and most preferably 1 to 50 nanometers. Particle diameter (formed by agglomeration of the nanoparticles) is typically measured using light scattering techniques known in the art. Primary particle diameter is typically measured using transmission electron microscopy or atomic force microscopy. As used herein, “discontinuous” means the nanoparticle coating is disposed as islands of nanoparticles or agglomerates thereof, surrounded by uncoated areas, such that the coating exhibits surface plasmon resonance. Continuous coatings, regardless of thickness, do not yield surface plasmon resonance. The nanoparticles may be substantially spherical, but in some cases are elongated, having an aspect ratio (length to diameter) of greater than 1.5:1 (i.e. are substantially oblong).

The coating generally has an average thickness is less than 100 nm, preferably less than 10 nm. Average thickness of the nanoparticle coating may be measured during deposition using a commercially available quartz crystal microbalance. After deposition a number of chemical assays can be used to characterize the quantity of metal in any specified area.

In another embodiment, the nanoparticle layer comprises a polymeric layer having metallic nanoparticles dispersed therein. The polymeric matrix may be a thermoplastic or thermoset polymer.

Techniques for producing nanoparticles include mechanical processing, chemical processing, or physical (thermal) processing. In mechanical processes, fine powders are commonly made from large particles using crushing techniques such as a high-speed ball mill. With chemical processes, nanoparticles are created from a reaction that precipitates particles of varying sizes and shapes using organometallic compounds or various metal salts. The chemical processes are often combined with thermal processing, e.g. pyrolysis. Thermal processing can take place in the gas or liquid phase. Gas phase syntheses include metal vapor condensation and oxidation, sputtering, laser-ablation, plasma-assisted chemical vapor deposition, and laser-induced chemical vapor deposition. Liquid phase processing encompasses precipitation techniques, and sol-gel processing. Aerosol techniques include spray drying, spray pyrolysis, and flame oxidation/hydrolysis of halides.

Of the aerosol processing techniques available for production of ceramic powders, spray pyrolysis and flame oxidation of halides are the primary methods used to produce ultrafine powders. In both methods, submicron sized droplets of solutions of metal salts or alkoxides can be produced by standard aerosolization techniques. In spray pyrolysis, the resulting aerosol is thermolyzed, to pyrolytically convert the aerosol droplet to an individual ceramic particle of the same stoichiometry as the parent solution. Thermal events in the process include solvent evaporation, solute precipitation, thermal conversion of the precipitate to a ceramic, and sintering of the particle to full density.

Spray pyrolysis is most commonly used for the preparation of metallic ceramic powders. The resultant powders typically have sizes in the 100-10,000 nm range. The particle sizes produced are controlled by the size of droplets within the aerosol and the weight percent dissolved solids in the solution. The final particle size decreases with smaller initial droplet sizes and lower concentrations of dissolved solids in solution.

Aerosolization may be accomplished by several well-known technologies. For example, a precursor solution may be atomized by flow through a restrictive nozzle at high pressure, or by flow into a high volume, low-pressure gas stream. When such atomizers are used, the high volume gas stream should be air, air enriched with oxygen, or preferably substantially pure oxygen. When high-pressure atomization through a restrictive orifice is used, the orifice may be surrounded by jets of one of the above gases, preferably oxygen. More than one atomizer for aerosolization may be positioned within the flame pyrolysis chamber. Other aerosol-producing methods, for example ultrasonic or piezoelectric droplet formation, may be used. However, some of these techniques may undesirably affect production rate. Ultrasonic generation is preferred, the aerosol generator generating ultrasound through resonant action of the oxygen flow and the liquid in a chamber. The aerosol is ignited by suitable means, for example laser energy, glow wire, electrical discharge, but is preferably ignited by means of an oxyhydrogen or hydrocarbon gas/oxygen torch. Prior to initiating combustion, the flame pyrolysis chamber is preheated to the desired operating range of 500 to 2000° C., preferably 700 to 1500° C., and most preferably 800 to 1200° C. Preheating improves particle size distribution and minimizes water condensation in the system. Preheating may be accomplished through the use of the ignition torch alone, by feeding and combusting pure solvent, i.e. ethanol, through the atomizer, by resistance heating or containment in a muffle furnace, combinations of these methods, or other means.

Many metallic nanoparticles are commercially available. Nanoshells are available from Nanospectra Biosciences, Inc., Houston, Tex. Many metallic nanoparticles are available from Nanostructured & Amorphous Materials, Inc., Houston, Nanomat, Inc. North Huntingdon, Pa., and Argonide Corporation Sanford, Fla.

In one embodiment, the article comprises a discreet coating of metallic nanoparticles on a reflective film layer, the article having the construction nanoparticles/polymer film/metal layer. In another embodiment, the article may comprise the construction nanoparticles/multilayer optical film (“MOF” as described more fully herein). In another embodiment the article may comprise the construction nanoparticles/total internal reflection (TIR) film. In another embodiment the article may comprise the construction nanoparticles/inorganic dielectric/metal.

Any of these embodiments may further comprise a polymer layer to protect the exposed, discreet, metallic nanoparticle layer from exposure of abrasion. This protective layer may comprise any thermoplastic or thermoset polymer (as described further herein) that is transmissive in the optical region of interest. Any of these embodiments may further comprise an adhesive layer for affixing the article to a substrate. Where the nanoparticle layer comprises a discreet coating on a reflective layer, incident light energy of a preselected wavelength, or wavelength region, causes localized heating of the nanoparticle layer resulting in melting, charring, or burning of the polymer matrix of the reflective layer and/or protective layer. Thus marks, text or other indicia may be inscribed on or in the article.

The nanoparticle coating may be deposited by conventional techniques, such as by vapor deposition techniques such as are described in Applicant's copending U.S. patent application Ser. No. 11/121,479, filed May 4, 2005, published as U.S. Publication No. 2006/0251874 and incorporated herein by reference. Alternatively, the nanoparticles may be applied as dispersion to the surface of the reflective layer, and the solvent removed.

In a preferred embodiment, the nanoparticle layer comprises a dispersion of metallic nanoparticles in a polymeric matrix. The metallic nanoparticles may be surface-modified or a dispersant may be added to reduce the tendency toward agglomeration. The matrix phase may be a thermoset polymer, or a thermoplastic polymer. The polymer is chosen to be at least 15%, preferably at least 25%, more preferably at least 50%, transmissive in the optical region of interest, as measured on the neat polymer. Preferably, the polymer is chosen so it is at least 15%, preferably at least 25%, more preferably at least 50% transmissive over at least a 100 nm wide band in a wavelength region of interest (bandwidth). Transmissivity may be measured on the neat polymer.

Generally, the wavelength or bandwidth of interest is that of the preselected incident light source. In such a construction, incident light energy of a preselected wavelength, or wavelength region, causes localized heating of the nanoparticle layer resulting in melting, charring, or burning of the polymer matrix of the nanoparticle layer. Thus marks, text or other indicia may be inscribed in the matrix rather than on the surface of the polymer matrix.

In one embodiment, the article comprises the construction: nanoparticle layer/polymer film/metal layer. In another embodiment, the article may comprise the construction nanoparticle layer/multilayer optical film (“MOF” as described more fully herein). In another embodiment the article may comprise the construction nanoparticle layer/Total internal reflection (TIR) film. In another embodiment the article may comprise the construction nanoparticle layer/inorganic dielectric/metal.

Thermoplastic polymers may be used to form the nanoparticle layer (and optional protective layer) of the present invention. Thermoplastic polymers which may be used in the present invention include but are not limited to melt-processable polyolefins and copolymers and blends thereof, styrene copolymers and terpolymers (such as Kraton™), ionomers (such as Surlin™), ethyl vinyl acetate (such as Elvax™), polyvinylbutyrate, polyvinyl chloride, metallocene polyolefins (such as Affinity™ and Engage™), poly(alpha olefins) (such as Vestoplast™ and Rexflex™), ethylene-propylene-diene terpolymers, fluorocarbon elastomers (such as THV™ from 3M Dyneon), other fluorine-containing polymers, polyester polymers and copolymers (such as Hytrel™), polyamide polymers and copolymers, polyurethanes (such as Estane™ and Morthane™), polycarbonates, polyketones, polyvinyl butyrals and polyureas.

Useful polyamide polymers include, but are not limited to, synthetic linear polyamides, e.g., nylon-6 and nylon-66, nylon-11, or nylon-12. It should be noted that the selection of a particular polyamide material might be based upon the physical requirements of the particular application for the resulting reinforced composite article. For example, nylon-6 and nylon-66 offer higher heat resistant properties than nylon-11 or nylon-12, whereas nylon-11 and nylon-12 offer better chemical resistant properties. In addition to those polyamide materials, other nylon materials such as nylon-612, nylon-69, nylon-4, nylon-42, nylon-46, nylon-7, and nylon-8 may also be used. Ring containing polyamides, e.g., nylon-6T and nylon-61 may also be used. Polyether containing polyamides, such as PEBAX polyamides (Atochem North America, Philadelphia, Pa.), may also be used.

Polyurethane polymers which can be used include aliphatic, cycloaliphatic, aromatic, and polycyclic polyurethanes. These polyurethanes are typically produced by reaction of a polyfunctional isocyanate with a polyol according to well-known reaction mechanisms. Commercially available urethane polymers useful in the present invention include: PN-04 or 3429 from Morton International, Inc., Seabrook, N.H., and X4107 from B.F. Goodrich Company, Cleveland, Ohio.

Also useful are polyacrylates and polymethacrylates which include, for example, polymers of acrylic acid, methyl acrylate, ethyl acrylate, acrylamide, methylacrylic acid, methyl methacrylate, n-butyl acrylate, and ethyl acrylate, to name a few.

Other useful thermoplastic polymers include substantially extrudable hydrocarbon polymers include polyesters, polycarbonates, polyketones, and polyureas. These materials are generally commercially available, for example: SELAR™ polyester (DuPont, Wilmington, Del.); LEXAN™ polycarbonate (General Electric, Pittsfield, Mass.); KADEL™ polyketone (Amoco, Chicago, Ill.); and SPECTRIM™ polyurea (Dow Chemical, Midland, Mich.).

Useful fluorine-containing polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Still other fluorine-containing polymers useful in the invention include those based on vinylidene fluoride such as polyvinylidene fluoride; copolymers of vinylidene fluoride with one or more other monomers such as hexafluoropropylene, tetrafluoroethylene, ethylene, propylene, etc. Still other useful fluorine-containing extrudable polymers will be known to those skilled in the art as a result of this disclosure.

The metallic nanoparticles are generally combined with the thermoplastic polymer (in the form of powders or pellets) and melt-processed, such as by injection molding, extrusion, casting, etc. The metallic nanoparticles may include surface treatment of the particles with surface modifying agents such as silanes, organic acids such as carboxylic acids, organic bases, alcohols, thiols and other types or mixtures of dispersants to improve the compatibility between the nanoparticles and the polymeric matrix, and reduce the tendency of the nanoparticles to agglomerate. Suitable acidic surface modifiers include, but are not limited to, 2[-2-(2-methoxyethoxy)ethoxy]acetic acid and hexanoic acid. Silane surface modifiers include, but are not limited to, methyltriethoxysilane, isobutyltrimethoxysilane and isooctyltrimethoxysilane.

Alternatively, the nanoparticles may be combined with one or more polymerizable monomers, including addition and condensation monomers and polymerized, optionally using a catalyst. As with melt processing, surfactants or surface-modified nanoparticles may be used to reduce agglomeration.

For a nanoparticle layer comprising a thermoplastic having nanoparticles dispersed therein, the nanoparticle layer may be separately prepared, and then bonded, adhered, or otherwise affixed to the reflective layer. In one embodiment, a molten thermoplastic polymer having metallic nanoparticles dispersed therein may be cast onto the surface of the reflective layer. In another embodiment, a mixture of nanoparticles and one or more polymerizable monomers, catalyst and solvent, may be coated on the surface of a reflective layer and polymerized in situ. In yet another embodiment, the nanoparticle layer and reflective layer may be coextruded.

Thermoset polymers may be used to form the nanoparticle layer of the present invention. As used herein, thermoset refers to a polymer that solidifies or sets irreversibly when cured. The thermoset property is associated with a crosslinking reaction of the constituents.

Suitable thermoset polymers include those derived from phenolic resins, epoxy resins, vinyl ester resins, vinyl ether resins, urethane resins, cashew nut shell resins, napthalinic phenolic resins, epoxy modified phenolic resins, silicone (hydrosilane and hydrolyzable silane) resins, polyimide resins, urea formaldehyde resins, methylene dianiline resins, methyl pyrrolidinone resins, acrylate and methacrylate resins, isocyanate resins, unsaturated polyester resins, and mixtures thereof.

A polymer precursor or precursors may be provided to form the desired thermoset polymer. The polymer precursor or thermoset resin may comprise monomers, or may comprise a partially polymerized, low molecular weight polymer, such as an oligomer, if desired. Solvent or curative agent, such as a catalyst, may also be provided where required. The nanoparticles may be dispersed in the polymer precursor or resin. The polymer precursor solution solvent, if any, may be removed by evaporation. The evaporation and polymerization may take place until the polymerization is substantially complete and the metallic nanoparticles dispersed therein.

The nanoparticles may be provided as neat or as a dispersion or suspension. The nanoparticles may be admixed with the polymer precursor or resin, and optional curative, and formed into a desired shape, such as cast into a film. One method includes mixing the nanoparticles, monomer, oligomer or resin and curative, and casting the solution into the desired shape, followed by curing. Another method includes extruding or injection molding a mixture comprising nanoparticles, polymer precursor, and optional curative, followed by curing. In addition, other manufacturing techniques may be used in including but not limited to, hand layup, resin transfer molding, pultrusion, compression molding, autoclave, vacuum bag technique and filament winding

For a nanoparticle layer comprising a thermoset polymer having nanoparticles dispersed therein, the nanoparticle layer may be separately prepared, and then bonded and then bonded, adhered, or otherwise affixed to the reflective layer. In one embodiment, a mixture of nanoparticles and one or more polymerizable monomers, optional catalyst and solvent, may be coated on the surface of a reflective layer and polymerized in situ.

The reflective layer may comprise any material that can form a fully reflective or semi-reflective layer. “Reflective” means semi-reflective or fully reflective. “Semi-reflective” means neither fully reflective nor fully transmissive, generally less than about 70% reflective, more typically about 30 to about 70% reflective in the optical region of interest. “Fully reflective” means greater than 70% reflective in the optical region of interest

In one embodiment, the reflective layer may comprise a metallized layer directly on the nanoparticle layer, which in turn comprises a thermoplastic or thermoset polymer having metallic nanoparticles dispersed therein. In another embodiment the reflective layer may comprise a metallized substrate such as a polymeric film or inorganic substrate (such as glass) on which a layer of metal has been deposited. Suitable materials for the reflective layer include metals or semi-metals such as aluminum, chromium, gold, nickel, silicon, copper and silver. Other suitable materials that may be included in the reflective layer include metal oxides such as chromium oxide and titanium oxide. The reflective layer may also be made by standard vapor coating techniques such as evaporation, sputtering, chemical vapor deposition, plasma deposition, or flame deposition. Alternatively, the reflective layer may be prepared by plating a metal layer out of solution onto a suitable substrate.

Metallized films may be either fully- or semireflective as is known in the art. In some exemplary embodiments of the present invention, the metallized film reflective layer is at least about 90% reflective (i.e., at most about 10% transmissive or absorbent, measured normal to the film), and in some embodiments, about 99% reflective (i.e., about 1% transmissive or absorbent) at a preselected optical wavelength. Preferably, the metallized film reflective layer is at least about 90% reflective over at least a 100 nm wide band in a wavelength region of interest (bandwidth). Generally the wavelength or bandwidth of interest is that of the incident light source. Various metallized films are presently known and are commercially available.

The reflective layer may also comprise a multilayer article comprising at least one dielectric layer and at least one metal layer, such as are described in U.S. Pat. No. 4,450,201 (Brill et al.) and incorporated herein by reference. Briefly, a substrate carrier, such as for example glass, a polyester film or the like, has a metallic layer applied thereto. The metal may be silver, gold, aluminum, copper, or the like. The dielectric cover layer is applied to the metal layer and the dielectric layer, including a metal-nitrogen compound. Either the dielectric cover layer or the metal layer can be adhered to or connected to the substrate carrier. The dielectric cover layer may comprise at least one compound selected from the group consisting of the oxides of titanium, silicon, tantalum, and zirconium and zinc sulfide, and, in addition thereto, a nitrogen compound having the same metal ion as said oxide or sulfide. The metal layer is preferably a transparent layer of at least one metal selected from the group consisting of silver, gold, aluminum or copper.

In a preferred embodiment, the dielectric cover layer is applied to both sides of the metal layer, that is, the dielectric cover layer is applied directly on the substrate carrier, over which the metal layer is applied, which then is covered by another dielectric cover layer. The dielectric cover layer, for example, may be a mixture of a metal oxide, a metal nitride, and oxinitride, for example titanium dioxide and titanium nitride.

The transmissivity to light of the metal layer depends on the reflectivity within the preselected spectral range. The reflectivity is a function of the refractive index of the material. The metal layer has a high index of refraction within the visible spectral range.

In another embodiment, the reflective layer may be a total internal reflection (TIR) film. It is known that when light is incident on a medium having a lesser refractive index, the light rays are bent away from the normal, so the exit angle is greater than the incident angle. Such reflection is commonly called “internal reflection”. The exit angle will then approach 90° for some critical incident angle θ_{c}, and, for incident angles greater than the critical angle, there will be total internal reflection. The critical angle can be calculated from Snell's law by setting the refraction angle equal to 90°.

In the instant invention, if light is transmitted though a nanoparticle layer (in such embodiments where the nanoparticle layer comprises metallic nanoparticles dispersed in a polymer matrix) having a first index of refraction, and then is impinges on a second polymer layer having a lower index of refraction, internal reflection may result. Thus, the reflection layer may be selected to have an index of refraction at least about 0.05 units less than the index of refraction of the nanoparticle polymer layer, even though the reflection polymer layer itself is not reflective.

In another embodiment, the TIR reflective layer may comprise two or more polymer layers (in addition to the nanoparticle polymer layer), each having different refractive indices. Said TIR films are known, for example, from European Patent No. EP 225,123, to which reference may be made for a detailed description of their features. An example of said TIR films are those produced and marketed by 3M Company under the brand name of OLF-Optical Lighting Film. They are shaped as flexible sheets or tapes, exhibiting a surface with a series of parallel micro-relieves with a substantially triangular section; such films can be applied onto the surface of nanoparticle layer, with the micro-relieves oriented in the propagation direction and usually facing outwards, thus creating an effective light guide.

In another embodiment, the reflective layer may comprise a multilayer optical film (“MOF”). The construction, materials, and optical properties of multilayer optical films are generally known, and were first described in Alfrey et al., Polymer Engineering and Science, Vol. 9, No. 6, pp 400-404, November 1969; Radford et al., Polymer Engineering and Science, Vol. 13, No. 3, pp 216-221, May 1973; and U.S. Pat. No. 3,610,729 (Rogers). More recently patents and publications including U.S. Pat. No. 5,882,774 (Ouderkirk et al.), U.S. Pat. No. 6,613,421 (Ouderkirk et al.), U.S. Pat. No. 6,117,530 (Ouderkirk et al.), U.S. Pat. No. 5,962,114 (Ouderkirk et al.), U.S. Pat. No. 5,965,247(Ouderkirk et al.), U.S. Pat. No. 6,635,337(Ouderkirk et al.), U.S. Pat. No. 6,296,927(Ouderkirk et al.), U.S. Pat. No. 5,095,210 (Wheatley et al.), U.S. Pat. No. 6,045,894 (Jonza et. al) and U.S. Pat. No. 5,149,578 (Wheatley et al.), discuss useful optical effects which can be achieved with large numbers of alternating thin layers of different polymeric materials that exhibit differing optical properties, in particular different refractive indices in different directions. The contents of all of these references are incorporated by reference herein.

Multilayer polymeric films can include hundreds or thousands of thin layers, and may contain as many materials as there are layers in the stack. For ease of manufacturing, preferred multilayer films have only a few different materials, and for simplicity those discussed herein typically include only two, which includes a first polymer A having an actual thickness d₁, and a second polymer B having an actual thickness d₂. The multilayer film includes alternating layers of a first polymeric material having a first index of refraction, and a second polymeric material having a second index of refraction that is different from that of the first material. The individual layers are typically on the order of 0.05 micrometers to 0.45 micrometers thick. As an example, the PCT Publication to Ouderkirk et al. discloses a multilayered polymeric film having alternating layers of crystalline naphthalene dicarboxylic acid polyester and another selected polymer, such as copolyester or copolycarbonate, wherein the layers have a thickness of less than 0.5 micrometers, and wherein the refractive indices of one of the polymers can be as high as 1.9 in one direction and 1.64 in the other direction.

Adjacent pairs of layers (one having a high index of refraction, and the other a low index) preferably have a total optical thickness that is ½ of the wavelength of the light desired to be reflected. For maximum reflectivity the individual layers of a multilayer polymeric film have an optical thickness that is ¼ of the wavelength of the light desired to be reflected, although other ratios of the optical thicknesses within the layer pairs may be chosen for other reasons. These preferred conditions are expressed in Equations 1 and 2, respectively. Note that optical thickness is defined as the refractive index of a material multiplied by the actual thickness of the material, and that unless stated otherwise, all actual thicknesses discussed herein are measured after any orientation or other processing. For biaxially oriented, multilayer optical stacks at normal incidence, the following equation applies:

λ/2=t₁+t₂=n₁d₁+n₂d₂ Equation 1

λ/4=t₁=t₂=n₁d₁=n₂d₂ Equation 2
where λ=wavelength of maximum light reflection
t₁=optical thickness of the first layer of material
t₂=optical thickness of the second layer of material and
n₁=in-plane refractive index of the first material
n₂=in-plane refractive index of the second material
d₁=actual thickness of the first material
d₂=actual thickness of the second material

By creating a multilayer film with layers having different optical thicknesses (for example, in a film having a layer thickness gradient), the film will reflect light of different wavelengths. The selection of layers having desired optical thicknesses (by selecting the actual layer thicknesses and materials) enables the reflection of light in the preselected portion of the spectrum, including the UV, visible and IR portions of the spectrum. Moreover, because pairs of layers will reflect a predictable bandwidth of light, as described below, individual layer pairs may be designed and made to reflect a given bandwidth of light. Thus, if a large number of properly selected layer pairs are combined, superior reflectance of a desired portion of the spectrum can be achieved.

A variety of MOFs can be employed. A preferred method for preparing a suitable MOF involves biaxially orienting (stretching along two axes) a suitable multilayer polymeric film. If the adjoining layers have different stress-induced birefringence, biaxial orientation of the multilayer optical film results in differences between refractive indices of adjoining layers for planes parallel to both axes, resulting in the reflection of light of both planes of polarization. A uniaxially birefringent material can have either positive or negative uniaxial birefringence. Positive uniaxial birefringence occurs when the index of refraction in the z direction (n_{z}) is greater than the in-plane indices (nₓ and n_{y}). Negative uniaxial birefringence occurs when the index of refraction in the z direction (n_{z}) is less than the in-plane indices (nₓ and n_{y}).

If n¹_{z} is selected to match n²ₓ=n²_{y}=n²_{z} and the multilayer optical film is biaxially oriented, there is no Brewster's angle for p-polarized light and thus there is constant reflectivity for all angles of incidence. Multilayer optical films that are oriented in two mutually perpendicular in-plane axes are capable of reflecting an extraordinarily high percentage of incident light depending on factors such as the number of layers, the f-ratio (the ratio of the optical thicknesses in a two component multilayer optical film, see U.S. Pat. No. 6,049,419) and the indices of refraction, and are highly efficient mirrors.

In some embodiments MOFs are highly reflective for both s and p polarized light for any incident direction, and have an average reflectivity of at least 30%, preferably at least 50%, more preferably 70%, and most preferably 90%, over at least a 100 nm wide band in a wavelength region of interest (measured normal to the film). Reflectivity is measured on the MOF film in the absence of the nanoparticle layer or other layers.

The wavelength region of interest may vary widely depending on the nature of the nanoparticles and polymers used. Thus, the wavelength region of interest may be within the infrared region (about 700 nm to about 2000 nm), the visible region (about 380 nm to about 700 nm) or the ultraviolet region (about 300 nm to about 380 nm), and the film is engineered to reflect incident radiation over at least a 100 nm wide band in that region. Regions outside of the reflective bandwidth may be engineered to be either absorbent or transmissive, as desired.

In one preferred IR reflecting MOF layer embodiment, the MOF support is a two component narrow-band multilayer optical film designed to eliminate visible color due to higher order reflections that occur in the visible region of the spectrum from first order reflecting bands that occur in the IR region above about 1200 nm. The bandwidth of light to be blocked, i.e., not transmitted, by this MOF layer at a zero degree observation angle is from approximately 700 to 1200 nm. To further reduce visible color at non-normal angles, the short wavelength bandedge is typically shifted by about 100 to 150 nm away from the long wavelength visible bandedge into the IR so that the reflecting band does not shift into the visible region of the spectrum at maximum use angles. This provides a narrow-band IR reflecting MOF support that reflects from about 850 nm to about 1200 nm at normal angles. For a quarter wave stack, the layer pairs of such an MOF support preferably have optical thicknesses ranging from 425 to 600 nm ([½] the wavelength of the light desired to be reflected) to reflect the near infrared light. More preferably, for a quarter wave stack, such an IR reflecting MOF support has individual layers each with an optical thickness ranging from 212 to 300 nm ([¼] the wavelength of the light desired to be reflected), to reflect near infrared light.

In another MOF embodiment, the reflecting layer may comprise alternating layers of at least a first polymer and a second polymer having optical thicknesses of between approximately 360 nanometers and approximately 450 nanometers, the film transmitting substantially all incident visible light and reflecting light having a wavelength of from approximately 720 to 900 nanometers at approximately a zero degree observation angle, wherein the film comprises a series of layer pairs. Such articles are described in detail in U.S. Pat. No. 6,045,894.

In another embodiment, the MOF reflective layer comprises a mirror film comprising a plurality of alternating layers of at least a first and second polymeric material wherein at least one of the first or second polymeric materials is birefringent; and wherein the difference in indices of refraction of the first and second polymeric materials for visible light polarized along both mutually orthogonal in-plane axes of the film is at least 0.05; and wherein the difference in indices of refraction of the first and second polymeric materials for visible light polarized along a third axis normal to the plane of the film is less than about 0.05. Such visible mirror films are described in U.S. Pat. No. 6,080,467 (Weber et al.), U.S. Pat. No. 6,451,414 (Wheatley et al.) and U.S. Pat. No. 5,882,774 (Jonza et al.), each incorporated herein by reference.

In another MOF embodiment, the layer pairs in the MOF support have varying relative thicknesses, referred to herein as a layer thickness gradient, which are selected to achieve the desired bandwidth of reflection over a widened reflection band. For example, the layer thickness gradient may be linear, with the thickness of the layer pairs increasing at a constant rate across the thickness of the MOF support, so that each layer pair is a certain percent thicker than the thickness of the previous layer pair. The layer thicknesses may also decrease, then increase, then decrease again from one major surface of the MOF support to the other, or may have an alternate layer thickness distribution designed to increase the sharpness of one or both bandedges, e.g., as described in U.S. Pat. No. 6,157,490.

In yet another MOF embodiment, the MOF can include an extended bandedge, two component, IR reflecting film construction having a six layer alternating repeating unit as described in U.S. Pat. No. 5,360,659. This construction suppresses the unwanted second, third, and fourth order reflections in the visible wavelength region of between about 380 to about 700 nm, while reflecting light in the infrared wavelength region of between about 700 to about 2000 nm. Reflections higher than fourth order will generally be in the ultraviolet, not visible, region of the spectrum or will be of such a low intensity as to be unobjectionable. Such an MOF support has alternating layers of first (A) and second (B) polymeric materials in which the six layer alternating repeat unit has relative optical thicknesses of about 0.778A.111B.111A.778B.111A.111B. The use of only six layers in the repeat unit results in more efficient use of material and is relatively easy to manufacture. In such an embodiment it is also desirable to introduce a repeat unit thickness gradient as described above across the thickness of the MOF support.

In yet another MOF embodiment, the MOF can include more than two optically distinguishable polymers. A third or subsequent polymer can for example be employed as an adhesion-promoting layer between a first polymer and a second polymer within an MOF support, as an additional component of a stack for optical purposes, as a protective boundary layer between optical stacks, as a skin layer, as a functional coating, or for any other purpose. As such, the composition of a third or subsequent polymer, if any, is not limited. Examples of MOF supports that contain more than two distinguishable polymers include those described in U.S. Reissue No. Re 34,605, incorporated herein by reference. Re No. 34,605 describes a film including three diverse substantially transparent polymeric materials, A, B, and C, and having a repeating unit of ABCB. The layers have an optical thickness of between about 90 nm to about 450 nm, and each of the polymeric materials has a different index of refraction, nᵢ. A layer thickness gradient can also be introduced across the thickness of such an MOF support, with the layer thicknesses preferably increasing monotonically across the thickness of the MOF support. Preferably, for a three component system, the first polymeric material (A) differs in refractive index from the second polymeric material (B) by at least about 0.03, the second polymeric material (B) differs in refractive index from the third polymeric material (C) by at least about 0.03, and the refractive index of the second polymeric material (B) is intermediate between the respective refractive indices of the first (A) and third (C) polymeric materials. Any or all of the polymeric materials may be synthesized to have the desired index of refraction by utilizing a copolymer or miscible blend of polymers.

Yet another MOF embodiment is described in U.S. Pat. No. 6,207,260. The optical films and other optical bodies of that patent exhibit a first order reflection band for at least one polarization of electromagnetic radiation in a first region of the spectrum while suppressing at least the second, and preferably also at least the third, higher order harmonics of the first reflection band. The percent reflection of the first order harmonic remains essentially constant, or increases, as a function of angle of incidence. This is accomplished by forming at least a portion of the MOF support out of polymeric materials, A, B, and C, which are arranged in a repeating sequence ABC, wherein A has refractive indices nₓ, n_{y}, and n_{z} along mutually orthogonal axes x, y, and z, respectively, B has refractive indices nₓ, n_{y}, and n_{z} along axes x, y and z, respectively, and C has refractive indices nₓ, n_{y} and n_{z} along axes x, y, and z, respectively, where axis z is orthogonal to the plane of the film or optical body, wherein nₓ^{A}>nₓ^{B}>nₓ^{C} or n_{y}^{A}>n_{y}^{B}>n_{y}^{C}, and wherein n_{z}^{C}≧n_{z}^{B} and/or n_{z}^{B}≧n_{z}^{A}. Preferably, at least one of the differences 2(n_{z}^{A}−n_{z}^{B})/(n_{z}^{A}+n_{z}^{B}) and 2(n_{z}^{B}−n_{z}^{C})/(n_{z}^{B}+n_{z}^{C}) is less than or equal to about −0.05. By designing the MOF support within these constraints, at least some combination of second, third and fourth higher-order reflections can be suppressed without a substantial decrease of the first harmonic reflection with angle of incidence, particularly when the first order reflection band is in the infrared region of the spectrum.

In yet another MOF embodiment, any of the above described MOF supports can be combined with a “gap-filler” component that increases the optical efficiency of the MOF when the reflecting band is selectively positioned away from the visible region of the spectrum to minimize perceived color change with angle. Such a component works at normal angles to absorb or reflect IR radiation in the region between the edge of the visible spectrum and the short wavelength bandedge of the IR reflecting band. Such an MOF support is described more fully in U.S. Pat. No. 6,049,419.

The materials selected for the layers in the stack also determine the reflectance characteristics of the MOF. Many different materials may be used, and the exact choice of materials for a given application depends on the desired match and mismatch obtainable in the refractive indices between the various optical layers along a particular axis, as well as on the desired physical properties of the finished film. For simplicity, the discussion that follows will concentrate on MOF supports containing layer pairs made from only two materials, referred to herein as the first polymer and the second polymer. For discussion purposes the first polymer will be assumed to have a stress optical coefficient with a large absolute value. Thus the first polymer will be capable of developing a large birefringence when stretched. Depending on the application, the birefringence may be developed between two orthogonal directions in the plane of the MOF support, between one or more in-plane directions and the direction perpendicular to the MOF support film plane, or a combination of these. The first polymer should maintain birefringence after stretching, so that the desired optical properties are imparted to the finished MOF support.

To make a reflective, or mirror, MOF, the refractive index criteria apply equally to any direction in the film plane. It is typical for the indices of any given layer to be equal or nearly so in orthogonal in-plane directions. Preferably, however, the in-plane indices of the first polymer differ as much as possible from the in-plane indices of the second polymer. If before orientation the first polymer has an index of refraction higher than that of the second polymer, the in-plane indices of refraction of the first polymer preferably increase in the direction of stretch, and the z-axis index preferably decreases to match that of the second polymer. Likewise, if before orientation the first polymer has an index of refraction lower than that of the second polymer, the in-plane indices of refraction of the first polymer preferably decrease in the direction of stretch, and the z-axis index preferably increases to match that of the second polymer. The second polymer preferably develops little or no birefringence when stretched, or develops birefringence of the opposite sense (positive-negative or negative-positive), such that its in-plane refractive indices differ as much as possible from those of the first polymer in the finished MOF support. These criteria may be combined appropriately with those listed above for polarizing films if an MOF support is meant to have some degree of polarizing properties as well.

For most applications, preferably the MOF polymer has no appreciable absorbance bands within the bandwidth of interest. Thus, all incident light within the bandwidth will be either reflected or transmitted. However, for some applications, it may be useful for one or both of the first and second polymers to absorb specific wavelengths, either totally or in part.

As noted above, the second polymer in the MOF preferably is chosen so that the refractive index of the second polymer differs significantly, in at least one direction in the finished MOF support, from the index of refraction of the first polymer in the same direction. Because polymeric materials are typically dispersive, that is, their refractive indices vary with wavelength, these conditions must be considered in terms of a particular spectral bandwidth of interest. It will be understood from the foregoing discussion that the choice of a second polymer is dependent not only on the intended application of the film of the invention, but also on the choice made for the first polymer and upon the MOF support and film processing conditions. The second optical layers can be made from a variety of second polymers having a glass transition temperature compatible with that of the first polymer and having a refractive index similar to the isotropic refractive index of the first polymer. Examples of suitable second polymers include vinyl polymers and copolymers made from monomers such as vinyl naphthalenes, styrene, maleic anhydride, acrylates, and methacrylates. Further examples of such polymers include polyacrylates, polymethacrylates such as poly (methyl methacrylate) (“PMMA”), and isotactic or syndiotactic polystyrene. Other suitable second polymers include condensation polymers such as polysulfones, polyamides, polyurethanes, polyamic acids, and polyimides. The second optical layers in the MOF support can also be formed from polymers such as polyesters and polycarbonates.

Preferred MOF support second polymers include homopolymers of PMMA such as those available from Ineos Acrylics, Inc. under the trade designations CP71 and CP80, and polyethyl methacrylate (“PEMA”) which has a lower glass transition temperature than PMMA. Additional preferred second polymers include copolymers of PMMA (“coPMMA”), e.g., a coPMMA made from 75 wt % methylmethacrylate (“MMA”) monomers and 25 wt % ethyl acrylate (“EA”) monomers such as that available from Ineos Acrylics, Inc., under the trade designation PERSPEX™ CP63; a coPMMA formed with MMA comonomer units and n-butyl methacrylate (“nBMA”) comonomer units; and a blend of PMMA and poly(vinylidene fluoride) (“PVDF”) such as that available from Solvay Polymers, Inc. under the trade designation SOLEF™ 1008. Yet other preferred second polymers include polyolefin copolymers such as the above-mentioned PE-PO ENGAGE™ 8200; poly (propylene-co-ethylene) (“PPPE”) available from Fina Oil and Chemical Co. under the trade designation Z9470; and a copolymer of atatctic polypropylene (“aPP”) and isotatctic polypropylene (“iPP”) available from Huntsman Chemical Corp. under the trade designation REXFLEX™ W111. Second optical layers can also be made from a functionalized polyolefin, e.g., a linear low density polyethylene-g-maleic anhydride (“LLDPE-g-MA”) such as that available from E.I. duPont de Nemours & Co., Inc. under the trade designation BYNEL™ 4105; from a copolyester ether elastomer (“COPE”) such as that available from Eastman Chemical Company under the trade designation ECDEL™; from syndiotactic polystyrene (“sPS”); from a copolymer or blend based upon terephthalic acid (“coPET”); from a copolymer of PET employing a second glycol, e.g., cyclohexanedimethanol (“PETG”); and from a fluoropolymer available from Minnesota Mining and Manufacturing Company (3M) under the trade designation THV™.

Particularly preferred combinations of first/second polymers for optical layers in reflective MOF support films include PEN/PMMA, PET/PMMA or PET/coPMMA, PEN/COPE, PET/COPE, PEN/sPS, PET/sPS, PEN/coPET, PEN/PETG, and PEN/THV. Several of these combinations provide constant reflectance with respect to the angle of incident light (that is, there is no Brewster's angle). For example, at a specific wavelength, the in-plane refractive indices might be 1.76 for biaxially oriented PEN, while the in-plane z-axis refractive index might fall to 1.49. When PMMA is used as the second polymer in the multilayer construction, its refractive index at the same wavelength might be 1.495 in all three directions. Another example is the PET/COPE system, in which the analogous in-plane and z-axis indices might be 1.66 and 1.51 for PET, while the isotropic index of COPE might be 1.52.

The article optionally includes one or more non-optical layers, e.g., one or more non-optical skin layers or one or more non-optical interior layers such as a protective boundary layer (“PBL”) between packets of optical layers. Non-optical layers can be used to give further strength or rigidity to the MOF support or to protect it from harm or damage during or after processing. For some applications, it may be desirable to include one or more sacrificial protective skins, wherein the interfacial adhesion between the skin layer(s) and the MOF support is controlled so that the skin layers can be stripped from the MOF support or from the underside of the finished film before use. Materials may also be chosen for the non-optical layers to impart or improve various properties, e.g., tear resistance, puncture resistance, toughness, weatherability, and solvent resistance of the articles of the invention.

The non-optical layers in such an MOF support can be selected from many appropriate materials. Factors to be considered in selecting a material for a non-optical layer include percent elongation to break, Young's modulus, tear strength, adhesion to interior layers, percent transmittance and absorbance in an electromagnetic bandwidth of interest, optical clarity or haze, refractive indices as a function of frequency, texture, roughness, melt thermal stability, molecular weight distribution, melt rheology, coextrudability, miscibility and rate of inter-diffusion between materials in the optical and non-optical layers, viscoelastic response, relaxation and crystallization behavior under draw conditions, thermal stability at use temperatures, weatherability, ability to adhere to coatings and permeability to various gases and solvents. Of course, as previously stated, it is important that the chosen non-optical layer material not have optical properties deleterious to those of the MOF support. The non-optical layers may be formed from a variety of polymers, such as polyesters, including any of the polymers used in the article.

In general, the wavelength of the incident light source used to mark the article of the invention corresponds to the wavelength of maximum absorbance of the nanoparticles of the nanoparticle layer. Preferably, the bandwidth of the incident light sources overlaps with the absorbance bandwidth of the nanoparticles of the nanoparticle layer and the reflectance bandwidth of the reflective layer.

Examples of suitable light sources which can be employed are a high pressure mercury arc lamp, a ultra-high pressure mercury arc lamp, a carbon arc, a xenon arc lamp, a laser, a tungsten filament incandescent lamp, a luminescent discharge tube, a cathode ray tube, sunlight, light emitting diodes, etc. Other useful light sources include various lasers, for example, argon ion, diode, excimer, and dye lasers. In the case of lasers, the exposure times are dependent upon the spatial distribution of the laser beam and power of the lasers. Generally the amount of power/unit area necessary to mark the instant article is greater than that of incident solar radiation over a 100 nm bandwidth at the absorption band of the nanoparticles. More specifically, the incident irradiance should exceed 20 mW/cm².

Filters may be used to selectively transmit a desired wavelength or bandwidth to the surface of the articles. Further, sensitizers may be incorporated into the nanoparticle layer or reflective layer which shift the wavelength of the incident light energy to the absorption band of the nanoparticles.

Suitable sensitizers include ketones, coumarin dyes (e.g., keto-coumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes and pyridinium dyes. Ketones (e.g., monoketones or alpha-diketones), ketocoumarins, aminoarylketones and p-substituted aminostyryl ketone compounds are preferred sensitizers. For applications requiring high sensitivity, it is preferred to employ a sensitizer containing a julolidinyl moiety. For applications requiring deep cure (e.g., where the coating attenuate radiation of similar wavelengths), it is preferred to employ sensitizers having an extinction coefficient below 1000, more preferably below 100, at the desired wavelength of irradiation for photopolymerization.

The intensity of the light is selected so the exposure time is in the range of from about 0.1 microseconds to about 1 minute, and more preferably from about 0.5 microseconds to about 15 seconds.

An exemplary imaging or marking process according to this invention consists of directing collimated light from a laser toward the nanoparticle layer. To create a mark, image or indicia the light impinges on the nanoparticles, which absorb the radiant energy and convert it to heat. This heat results in localized melting or charring of the polymer adjacent to the nanoparticle and permanently changes the optical characteristics thereof, such as by darkening, changing the color, or changing the refractive index of the polymer. Light energy not absorbed by the nanoparticles of the nanoparticle layer impinges on the reflective layer, to be reflected back toward the nanoparticle layer thereby increasing the efficiency of light-to-heat energy conversion of the nanoparticles.

Another method for forming a mark, image or indicia of the article uses a highly divergent light source. A preselected pattern may be imparted by selective illumination of the article, such as by means of a mask. This mask will have transmissive areas corresponding to all or sections of the image that are to be exposed and non-transmissive or reflective areas where the image should not be exposed. By having the mask fully illuminated by the incident energy, the portions of the mask that allow energy to pass through will impinge upon only certain regions of the nanoparticle layer. As a result, only a single light pulse is needed to form the mark, indicia or image. Alternatively, in place of a mask, a beam positioning system, such as a galvometric by scanner, can be used to locally illuminate the preselected areas of the nanoparticle layer and trace the composite image.

Adhesives may be used to laminate the markable films of the present invention to another film, surface, or substrate. Typically, adhesive layers will be on the major surface of the reflective layer opposite the nanoparticle layer. Such a construction may be depicted as nanoparticle layer/reflective layer/adhesive layer. Such adhesives include both optically clear and diffuse adhesives, as well as pressure sensitive and non-pressure sensitive adhesives. Pressure sensitive adhesives are normally tacky at room temperature and can be adhered to a surface by application of, at most, light finger pressure, while non-pressure sensitive adhesives include solvent, heat, or radiation activated adhesive systems. Examples of adhesives useful in the present invention include those based on general compositions of polyacrylate; polyvinyl ether; diene-containing rubbers such as natural rubber, polyisoprene, and polyisobutylene; polychloroprene; butyl rubber; butadiene-acrylonitrile polymers; thermoplastic elastomers; block copolymers such as styrene-isoprene and styrene-isoprene-styrene block copolymers, ethylene-propylene-diene polymers, and styrene-butadiene polymers; polyalphaolefins; amorphous-polyolefins; silicone; ethylene-containing copolymers such as ethylene vinyl acetate, ethylacrylate, and ethylmethacrylate; polyurethanes; polyamides; polyesters; epoxies; polyvinylpyrrolidone and vinylpyrrolidone copolymers; and mixtures of the above.

Additionally, the adhesives can contain additives such as tackifiers, plasticizers, fillers, antioxidants, stabilizers, pigments, diffusing particles, curatives, and solvents. When a laminating adhesive is used to adhere an optical film of the present invention to another surface, the adhesive composition and thickness are preferably selected so as not to interfere with the optical properties of the optical film. For example, when laminating additional layers to an optical polarizer or mirror wherein a high degree of transmission is desired, the laminating adhesive should be optically clear in the wavelength region that the polarizer or mirror is designed to be transparent in.

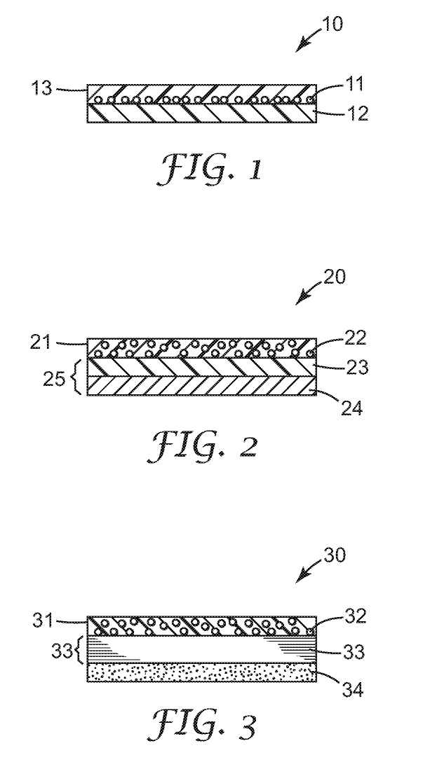

FIG. 1 illustrates an embodiment of the invention. Multilayer article 10 comprises a metallic nanoparticle layer 11 disposed as a discreet coating on reflective layer 12. Metallic nanoparticle layer 11 may be coated on all or a portion of reflective layer 12. In some embodiments, nanoparticle layer 11 may be pattern coated of reflective layer 12, such as by vapor deposition though a mask, or printing techniques. Reflective layer 12 may comprise a metallized film, a multilayer optical film, or a total internal reflection film. Article 10 may optionally include a protective layer 13. If desired, the nanoparticle layer may comprise a pattern coating on all or part of the reflective layer 12.

In practice, incident light energy of a preselected wavelength or bandwidth impinges on the nanoparticle surface 11, converting light energy to heat energy. This induces localized melting, charring or burning of the polymer layer of reflective layer 12, and the protective layer 13, if present. Some of the light energy that normally would be transmitted through the article 10 is reflected back by the reflective layer 12 to the nanoparticle layer 11, allowing more efficient absorption and conversion of the incident light energy. As result of the light energy, the article may be marked or inscribed as desired, such as with text or other indicia.

FIG. 2 represents an alternate embodiment. Multilayer article 20 comprises a polymer layer 21 containing dispersed metallic nanoparticles 22. The nanoparticles may be homogenously or nonhomogenously dispersed through the volume of layer 21. The polymer layer 21 is bonded to an adjacent polymer layer 23, which in turn is bonded to a metal film or foil layer 24. Polymer layer 21 may cover all or a portion of the surface of layer 23. In some embodiments, the nanoparticle-containing layer 21 may be pattern coated on layer 23. In an alternative embodiment, polymer layer 21 is bonded to metal layer 24.

Together, layers 23 and 24 constitute the reflective layer 25. The polymer layer 21 may be contiguous (sharing the same edges) to the adjacent layer 23, or it may cover a portion of layer 23. Again, incident light may be absorbed by the metallic nanoparticles, or may be transmitted through the polymer layer 21 to be reflected back by the reflective layer. The light-to-heat conversion of the incident light causes localizes melting, charring or burning of the polymer matrix 21, allowing the article to be inscribed. With respect to the polymer layer 21, incident light may be focused at a preselected depth in the polymer layer by means of lenses, so that the mark or indicia is inscribed at a preselected depth.

In an alternate embodiment, the reflective layer 25 may comprise a first polymer layer 23 having a first index of refraction, and a second polymer layer 24, having a lower index of refraction. Here, the different refractive indices causes total internal reflection of incident light.

In FIG. 3, multilayer article 30, comprises a polymer layer 31 having metallic nanoparticles 32 dispersed therein. The nanoparticles may be homogenously or nonhomogenously dispersed through the volume of layer 31. The nanoparticle-containing layer is bonded to a multilayer optical film (MOF) 33, which comprises a plurality of fine layers, which together provide a reflective layer. Polymer layer 31 may be contiguous with MOF layer 33 or may comprise just a potion of the layer 33. Light transmitted through the polymer layer 31 is reflected back by the MOF layer 33. The light-to-heat conversion of the incident light causes localizes melting, charring or burning of the polymer matrix 31, allowing the article to be inscribed. Article 30 is shown with an optional adhesive layer 34 bonded to the MOF layer 33 for affixing the article to other substrates.

### EXAMPLES

The following examples are merely for illustrative purposes only and are not meant to be limiting on the scope of the appended claims. All parts, percentages, ratios, etc. in the examples and the rest of the specification are by weight, unless noted otherwise.

### Example 1

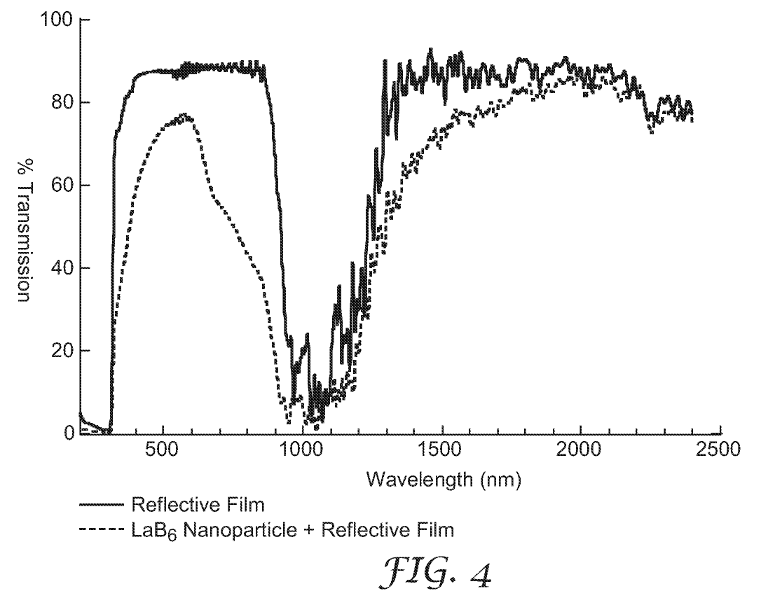

A sample was prepared by die-coating a dispersion of lanthanum hexaboride (LaB₆) nanoparticles onto a portion of 3M Solar Reflective Film (SRF), followed by UV curing with a D fusion bulb. The dispersion was made by combining 17.8% of KHF-7A, which is available from Sumitomo Metal Mining (Tokyo, Japan) and consists of 1.85% LaB₆, 2.65% ZrO₂ and 2.6% a binder in toluene, with 12.4% Vitel 2200 from Bostik Findley (Wauwatosa, Wis.), 5.3% Actilane 420 from Akzo Nobel (Arnhem, The Netherlands), 0.9% Irgacure 651 from Ciba Geigy (Dover Township, N.J.) and 63.6% MEK. The thickness of the SRF was 55.88 microns and the thickness of the sample was 81.28 microns. The transmission spectra of the SRF and the sample are shown in FIG. 4.

The sample was exposed to an 800 nm titanium-sapphire femtosecond laser (Spectra Physics, Irvine, Calif.) at a scan speed of 1.27 meters per minute. The laser has a pulse duration of 150 femtoseconds and a pulse rate of 1 kHz, and an average power of 660 milliwatts. The laser beam was focused on a point above the sample with the distance between the sample and the focal point as: 0.1, 0.075 and 0.05 mm. The part of the sample sensitized by nanoparticles was affected (heated and molten) at every one of the three focal distances chosen, while the part of the sample with no nanoparticle sensitization was affected only at the closest distance from the focal point (0.05 mm). Note that the 800 nm laser is outside of the wavelength range where the SRF reflects.

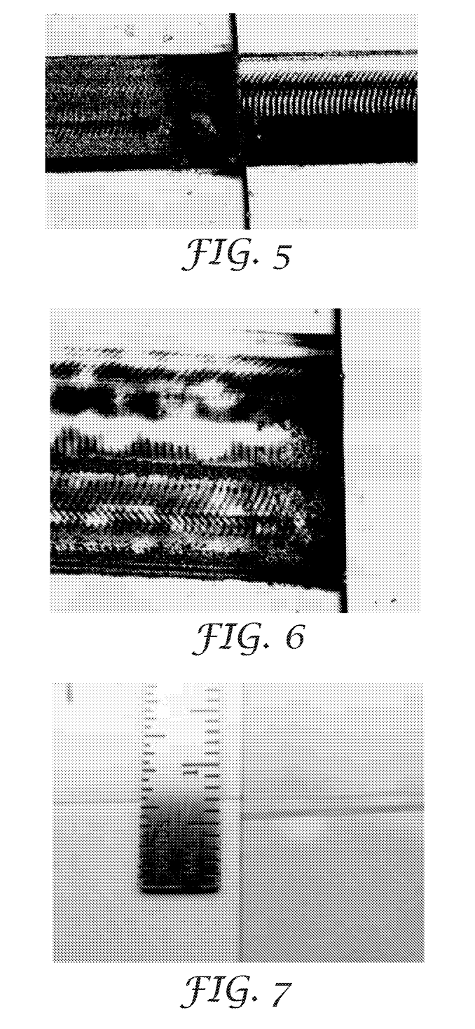

FIG. 5 is an electron micrograph of the imaged article where the incident laser source is 0.1 mm from the surface. In the micrograph, the left side of the vertical line is coated with the LaB₆ nanoparticles while the right side is uncoated. As the incident light is sufficiently intense and the reflective layer is essentially nonreflective at 800 nm, both coated and uncoated surfaces are imaged by the laser.

FIG. 6 is an electron micrograph of the imaged article where the incident laser source is 0.075 mm from the surface. Again, the left side of the vertical line is coated with the LaB₆ nanoparticles while the right side is uncoated. As the incident light is less intense (as result of the further spacing), only the nanoparticle-coated surface is imaged.

FIG. 7 is an electron micrograph of the imaged article where three inscribed marks (lines) may be seen, corresponding the incident laser source at 0.1, 0.075 and 0.05 mm from the surface (top to bottom). At the high intensity of 0.1 mm, both the coated (right side) and uncoated (left side) of the article is imaged. At the lower intensities, only the nanoparticle coated surface is imaged.

Furthermore, the sample was exposed to a Neodymium YLF laser beam (Cutting Edge Optronics, St. Charles, Mo.) having a wavelength of 1064 nm, a pulse duration of 15 nanoseconds, and an average power of 6.2 watts. Smoking or material evaporation was noticed as the laser beam reached the part of the sample sensitized by nanoparticles but none was observed when holding the beam for a given period of time on the part of the sample with no nanoparticle sensitization. This is attributed to the high degree of reflectivity that the SRF has in this wavelength range.

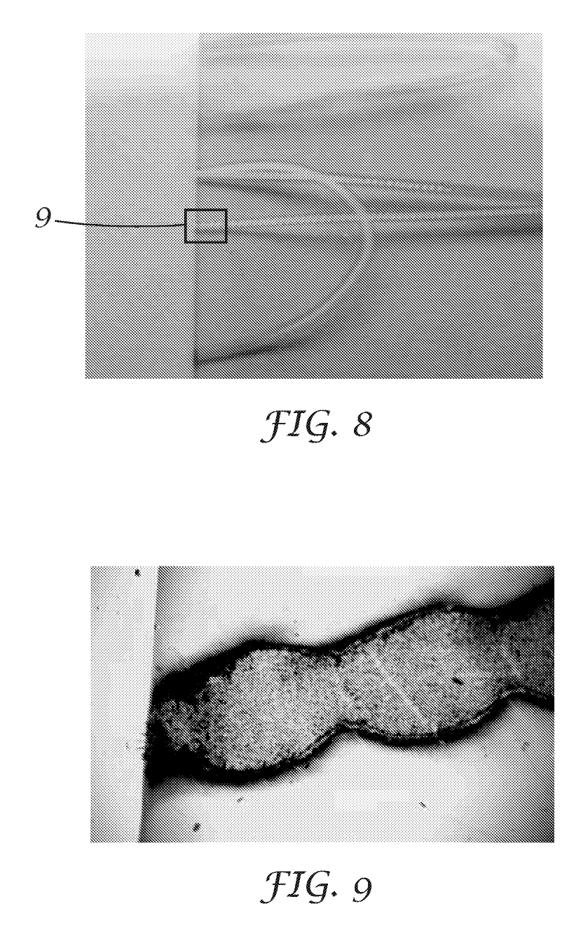

The results are shown in FIGS. 8 and 9. Note despite the higher power of the Neodymium laser (6.2 watts) vs. the sapphire laser (660 milliwatts), only the nanoparticle-coated (right side) is imaged. In FIG. 9 a close up micrograph of the boundary of an imaged area reveal essentially no imaging in the uncoated portion.

### Example 2

A dispersion of gold/silica nanoshells obtained from Nanospectra Inc. (Houston, Tex.) was made by dispersing those nanoshells into bis-GMA resin (available from Esstech, Essington, Pa.) and then blending it with 1% Irgacure 819 from Ciba Geigy (Dover Township, N.J.). The extinction coefficient of the nanoshells was 2.2 in the range of 1000 to 1100 nm. The silica core radius of the nanoshells is about 430 nm. Samples were prepared by die-coating the dispersion onto a variety of reflective substrates including copper, aluminum, glass slide and silicon wafer. The nanoshell coatings were cured with a 350 BLB Phillips bulb at a distance of 25.4 mm for 15 minutes. The thickness of the coatings is 0.5 mm. The samples were then marked with a 1064 nm Nd:YOV4 diode pumped laser (Lumera Laser GmbH, Kaiserslautem Germany) having a pulse duration of 13 picoseconds and a pulse rate of 15 kHz, and an average power of 2 watts. Marks on all samples were visible to the naked eye, but defocusing the beam resulted in a more effective marking of the nanoshell coating where the reflective substrate is metallic.

### Example 3

A dispersion of LaB₆ nanoparticles in isopropyl alcohol was prepared by ball-milling. 50 g of LaB₆ powder (Alfa 43100™, available from Alfa Aesar, Ward Hill, Mass.) was milled for 212 hours with 200 g of isopropyl alcohol in a 1.3-liter porcelain jar with 1750 g of zirconia grinding media (Tosoh YTZ, 5 mm balls, available from Tosoh USA, Inc., Grove City, Ohio). The jar rotation speed was 100 rpm. After milling another 100 g of isopropyl alcohol was added to the slurry as the milled powder was rinsed from the jar and grinding media. During milling wear of the grinding media introduced 55.5 g of zirconia into the mill batch. So the solid portion of the slurry was 47.4% (67.4 vol %) LaB₆ and 52.6% (32.6 vol %) ZrO₂. The particle size distribution was:

| 700-600 nm | 0.2 Vol % |
|---|---|
| 600-500 | 0.0 |
| 500-400 | 2.2 |
| 400-300 | 13.0 |
| 300-200 | 17.4 |
| 200-100 | 45.6 |
| 100-0 | 21.6 |

The dispersion was placed onto a variety of reflective substrates including copper, aluminum, glass slide and silicon wafer, and left dried as a result of the evaporation of the solvent. The thickness of the resultant coatings was about 0.5 mils (12.7 micrometers). The samples were then marked with the same laser as used in Example 2. Along the laser path the color of the LaB₆ coatings was changed or the coatings were ablated. Marks or color change on all samples were visible to the naked eye.

### Example 4

A dispersion of ATO (antimony tin oxide) nanoparticles as used in Example 3 was made by incorporating 1% the nanoparticles into a mixture of SM 6080™ (available from Advanced Nano Products, Korea)/Sartomer CN120B80™ (available from Sartomer Company, Exton, Pa.) and Irgacure™ 819. Samples were prepared by die-coating the dispersion onto a variety of reflective substrates including copper, aluminum, glass slide and silicon wafer. The ATO coatings were cured with 350 BLB Phillips bulbs at a distance of 25.4 mm for 15 minutes. The thickness of the coatings is 0.5 mils (12.7 micrometers). The samples were then marked with the same laser as used in Example 2 & 3. Marks on all samples were visible to the naked eye, but defocusing the beam resulted in a more effective marking of the ATO coating where the reflective substrate is metallic.

What is claimed is:

1. A markable, multilayer article comprising a metallic nanoparticle layer and a reflective film layer having a degree of reflectivity of at least 30% at a preselected wavelength of incident light, wherein on exposure to light energy at the preselected wavelength, localized heating is induced in the metallic nanoparticle layer, changing the optical characteristics thereof and imparting a mark thereto.

2. The article of claim 1 wherein the metallic nanoparticle layer comprises a discreet, discontinuous nanoparticle layer on the reflective film layer.

3. The article of claim 1 wherein the metallic nanoparticle layer comprises a pattern of nanoparticles on the reflective layer.

4. The article of claim 2 further comprising a protective layer on said discreet, discontinuous nanoparticle layer.

5. The article of claim 1 wherein the metallic nanoparticle layer comprises a polymer layer having metallic nanoparticles dispersed therein.

6. The article of claim 5 wherein the polymer of said nanoparticle layer is at least 15% transmissive at the preselected wavelength.

7. The article of claim 5 wherein the polymer of said nanoparticle layer is at least about 15% transmissive over at least a 100 nm wide band in a wavelength region (bandwidth) that comprises the preselected wavelength.

8. The article of claim 1 wherein the reflective film layer comprises a metallized film layer.

9. The article of claim 8 wherein the reflective film layer is at least 90% reflective over at least a 100 nm wide band in a wavelength region (bandwidth) that comprises the preselected wavelength.

10. The article of claim 1 wherein the reflective film layer comprises a multilayer optical film.

11. The article of claim 1 wherein the metallic nanoparticle layer has an absorbance of at least 20% at the preselected wavelength.

12. The article of claim 1 wherein said reflective layer is a total internal reflection film layer.

13. The article of claim 12, wherein said metallic nanoparticle layer comprises metallic nanoparticles dispersed in a first polymer matrix, the first polymer having a first index of refraction, and said reflective layer comprises a polymer having a second index of refraction, wherein the indices of refraction differ by at least 0.05.

14. The article of claim 12, wherein said metallic nanoparticle layer comprises metallic nanoparticles dispersed in a polymer matrix, and said reflective layer comprises a first polymer layer adjacent the metallic nanoparticle layer, and a second polymer layer adjacent said first polymer layer, wherein the index of refraction of the first polymer layer is greater than the index of refraction of said second polymer layer by at least 0.05.

15. The article of claim 1 wherein the nanoparticles are selected from the group consisting of gold, aluminum, copper, iron, platinum, palladium, iridium, rhodium, osmium, ruthenium, titanium, cobalt, vanadium, magnesium, silver, zinc, and cadmium, indium, lanthanum, indium tin oxide (ITO) and antimony tin oxide (ATO), antimony indium tin oxide (AITO), tin, boron, lanthanum hexaboride, rare earth metals and mixtures and alloys thereof.

16. The article of claim 1 further comprising an adhesive layer.

17. The article of claim 1 wherein said metallic nanoparticle layer absorbs incident light energy in the infrared region of the spectrum.

18. The article of claim 1 wherein said metallic nanoparticle layer absorbs incident light energy in the visible region of the spectrum.

19. The article of claim 1 wherein said metallic nanoparticle layer absorbs incident light energy in the ultraviolet region of the spectrum.

20. The markable article of claim 1 wherein the metallic nanoparticle layer comprises a polymer layer having metallic nanoparticles dispersed therein, the polymer layer being at least about 50% transmissive over at least a 100 nm wide band in a wavelength region that comprises the preselected wavelength.

21. The markable article of claim 1 wherein the reflective layer comprises a multilayer article comprising at least one dielectric layer and at least one metal layer.

22. A method of marking comprising the steps of:
a. providing the article of claim 1,
b. impinging light energy of the preselected wavelength on at least a portion of a surface of the article of claim 1 to induce localized heating in the metallic nanoparticle layer and thereby changing the optical characteristics of the article.

23. The method of claim 22 wherein the wavelength of incident light energy overlaps the absorbance range of the metallic nanoparticle layer over at least a 100 nm wide band in a wavelength region of interest (bandwidth).

24. The method of claim 22 wherein the metallic nanoparticle layer comprises a polymer layer having metallic nanoparticles dispersed therein, the polymer layer being at least about 15% transmissive over at least a 100 nm wide band in a wavelength region of the incident light source.

25. The method of claim 22 wherein the reflective layer has a degree of reflectivity of at least 30% over at least a 100 nm wide band in a wavelength region of the incident light source.

26. The method of claim 22 wherein the metallic nanoparticle layer comprises a discreet, discontinuous nanoparticle layer on the reflective film layer.

27. The method of claim 22 wherein the metallic nanoparticle layer comprises a pattern of nanoparticles on the reflective layer.

28. The method of claim 23 further comprising a protective layer on said discreet, discontinuous metallic nanoparticle layer.

29. The method of claim 22 wherein the metallic nanoparticle layer comprises a polymer layer having metallic nanoparticles dispersed therein.

30. The method of claim 29 wherein the polymer of said metallic nanoparticle layer is at least 15% transmissive in the optical wavelength of interest.

31. The method of claim 22 wherein said reflective layer is a total internal reflection film layer.

32. The method of claim 31, wherein said metallic nanoparticle layer comprises metallic nanoparticles dispersed in a first polymer matrix, the first polymer having a first index of refraction, and said reflective layer comprises a polymer having a second index of refraction, wherein the indices of refraction differ by at least 0.05.

33. The method of claim 22, wherein said nanoparticle layer comprises metallic nanoparticles dispersed in a polymer matrix, and said reflective layer comprises a first polymer layer adjacent the metallic nanoparticle layer, and a second polymer layer adjacent said first polymer layer, wherein the index of refraction of the first polymer layer greater than the index of refraction of said second polymer layer by at least 0.05.

34. The method of claim 22 wherein the nanoparticles are selected from the group consisting of gold, aluminum, copper, iron, platinum, palladium, iridium, rhodium, osmium, ruthenium, titanium, cobalt, vanadium, magnesium, silver, zinc, and cadmium, indium, lanthanum, indium tin oxide (ITO) and antimony tin oxide (ATO), antimony indium tin oxide (AITO), tin, boron, lanthanum hexaboride, rare earth metals and mixtures and alloys thereof.

35. The method of claim 22 wherein said metallic nanoparticle layer absorbs incident light energy in the infrared region of the spectrum.

36. The method of claim 22 wherein said metallic nanoparticle layer absorbs incident light energy in the visible region of the spectrum.

37. The method of claim 22 wherein said metallic nanoparticle layer absorbs incident light energy in the ultraviolet region of the spectrum.
